(19) United States
(12) Patent Application Publication
(10) Pub. No.: US 2007/0036710 A1
(43) Pub. Date: Feb. 15, 2007

(54) Zirconia extrudates

(76) Inventors: Laurent Alain Fenouil, Houston, TX (US); Jacobus Johannes Cornelis Geerlings, Amsterdam (NL); Hans Michiel Huisman, The Hague (NL); Peter William Lednor, Amsterdam (NL); Carolus Matthias Anna Maria Mesters, Amsterdam (NL); Johannes Jacobus Maria Van Vlaanderen, Amsterdam (NL)

Correspondence Address: SHELL OIL COMPANY, P O BOX 2463, HOUSTON, TX, 772522463, US

(21) Appl. No.: 11/541,625

(22) Filed: Sep. 28, 2006

Related U.S. Application Data
(62) Division of application No. 10/753,714, filed on Jan. 8, 2004.
(60) Provisional application No. 60/441,570, filed on Jan. 21, 2003.

(51) Int. Cl. C01G 25/02

(52) U.S. Cl. 423/608

(57) ABSTRACT

A process for preparing a calcined zirconia extrudate comprising the steps of: a. preparing a shapable dough which comprises mixing and kneading a particulate zirconia with a solvent to obtain a mixture having a total solids content of from about 50% to about 85% by weight, b. extruding the shapable dough to form a zirconia extrudate, and c. drying and calcining the zirconia extrudate; characterized in that the particulate zirconia comprises no more than about 15% by weight of zirconia which is other than monoclinic zirconia. The calcined zirconium extrudates prepared according to the present invention exhibit significantly improved crush strength and is suitable as a catalyst or catalyst support in a wide range of chemical processes.

### FIELD OF THE INVENTION

The present invention relates to the preparation of calcined zirconia extrudates and their use as catalysts or catalyst carriers.

### BACKGROUND OF THE INVENTION

Zirconia (or zirconium dioxide) is a well-known material which is known for use as a catalyst carrier or catalyst in various processes. The zirconia can be used in a variety of formed bodies or shaped particles including spheres, cylinders, rings (hollow cylinders) and less symmetrical shapes such as granules. Cylinders can be prepared having a variety of cross-sectional shapes such as trilobes, quadrulobes, stars and circular.

Shaped zirconia particles can be prepared by a process of particle enlargement, starting from zirconia powder. A number of methods can be used to achieve particle enlargement, including pressure compaction, agglomeration and spray methods. Such methods are described in Perry's Chemical Engineers Handbook, McGraw-Hill International Editions (1984) ISBN 0 07-049479-7, pages 8-61.

Pressure compaction is particularly suitable in the case of catalysts since this can result in strong particles. Pressure compaction can be carried out in a variety of ways including extrusion (where a shapable mixture is extruded through an extruder equipped with a suitable die plate to give a cylindrical-type particle), roll-pressing (resulting in less symmetrical, granular shaped particles) or tableting (which produces particles of a very well defined shape).

Once formed, the shaped particles are commonly dried and then calcined in order to create porosity as well as to increase particle strength. Both of these characteristics are especially important in the case of catalysts.

An extrusion process is often preferred over a tableting process since the production rate for extrusion is many orders of magnitude greater than for tableting. In addition, tableting generally results in lower pore volumes which is often a limitation in catalytic applications. Extrusion is also preferred over roll pressing because extrusion produces particles having a much narrower particle size distribution. The combination of a compacting mill and a granulating mill in a roll-press process results in a granular material which has a broad particle size distribution which is often undesirable in the catalyst field since it enhances segregation in a packed bed of catalyst particles.

Thus far it has not been possible to extrude zirconia like other materials such as alumina in conventional extrusion equipment to give reasonably strong carriers after calcination. Due to its high thermal stability and its acid and base properties, zirconia is an interesting carrier material. It would therefore be desirable to prepare a zirconia extrudate which has sufficient strength to be of industrial importance.

Zirconia exists in a number of crystalline forms depending on the prevailing conditions. Thus under conditions of ambient temperature and pressure zirconia exists as a stable, monoclinic crystalline structure. Under extreme pressures or at higher temperatures, typically of the order of 450° C. to 1000° C., zirconia exists as a tetragonal crystalline structure. At even higher temperatures, typically in excess of 1500° C., a cubic crystalline phase forms. For a general discussion of the properties of zirconia, reference is made to Kirk-Othmer “Encyclopedia of Chemical Technology”, Second Edition, Volume 22, pages 651 to 655.

EP-A-0,510,772 (Shell) discloses a process for the preparation of a zirconia-based catalyst extrudate comprising mulling a mixture of zirconia and/or a zirconia precursor and a solvent, which mixture has a solids content of from 20 to 60% by weight, and extruding the mixture.

EP-B-0,716,883 (BASF) discloses a method of preparing catalysts or carriers consisting essentially of monoclinic zirconia. The method comprises precipitation of a zirconium salt with ammonia, wherein a zirconyl nitrate or zirconyl chloride solution is added to an aqueous ammonia solution at a decreasing pH from 14 to 6 and drying, calcination and tableting are carried out. There are no examples given of the preparation of zirconia extrudates.

U.S. Pat. No. 6,034,029 (BASF). discloses a process for the preparation of a zirconium dioxide powder which is largely monoclinic and which has a large surface area. There are no examples given of the preparation of zirconia extrudates.

It has now surprisingly been found that significant improvement in the extrudate strength is observed if the zirconia used to prepare the extrudate consists essentially of monoclinic zirconia.

### SUMMARY OF THE INVENTION

According to one aspect of the present invention there is provided a process for preparing a calcined zirconia extrudate comprising the steps of:

a. preparing a shapable dough which comprises mixing and kneading a particulate zirconia with a solvent to obtain a mixture having a total solids content of from about 50% to about 85% by weight,

b. extruding the shapable dough to form a zirconia extrudate, and

c. drying and calcining the zirconia extrudate;

characterized in that the particulate zirconia comprises no more than about 15% by weight of zirconia which is other than monoclinic zirconia.

According to the present invention there is also provided a calcined zirconia extrudate prepared according to the process described herein.

The calcined zirconia extrudates prepared according to the process of the present invention have significantly improved crush strength compared with zirconia extrudates prepared from particulate zirconia which comprises more than about 15% of zirconia which is other than monoclinic zirconia, for example, zirconia which is a mixture of tetragonal and monoclinic zirconia which comprises more than about 15% by weight of zirconia which is tetragonal zirconia or zirconia which consists solely of tetragonal zirconia.

### DETAILED DESCRIPTION OF THE INVENTION

A key feature of the present invention is that the particulate zirconia comprises no more than about 15% by weight of zirconia which is other than monoclinic zirconia. Hence the particulate zirconia herein does not contain substantial amounts of zirconia which is other than monoclinic zirconia, such as cubic or tetragonal zirconia. Preferably, the particulate zirconia should contain no more than about 10% by weight, preferably no more than about 5% by weight, of zirconia which is not monoclinic.

X-ray diffraction can be used as a method for determining the relative amounts of tetragonal, monoclinic and cubic zirconia in a zirconia sample, as described in R. Jenkins and R. L. Snyder, Introduction to X-ray powder diffractometry (Chemical analysis Volume 138), John Wiley & Sons, New York (1996), ISBN 0-471-51339-3.

An example of a suitable particulate zirconia source for use herein is DAIICHI RC-100 which is commercially available from DDK Daiichi Kigenso Kagaku Kogyo Co. Ltd., 4-4-14 Koraibashi Chuo-ku, Osaka 541-0043, Japan.

The first step in the present process is the preparation of a shapable dough comprising mixing and kneading the particulate zirconia described above with a solvent, and optional additives, to obtain a mixture having a total solids content of from about 50% to about 85% by weight, preferably from about 55% to about 80% by weight, more preferably from about 65% to about 75% by weight.

As used herein the term “solvent” means any liquid which is suitable for use in preparing a shapable dough when mixed with the particulate zirconia, and, if present, the cobalt precursor.

The solvent may be any of the suitable solvents known in the art, for example, water; alcohols such as methanol, ethanol and propanol; ketones, such as acetone; aldehydes, such as propanal; and aromatic diluents, such as toluene. Preferably and most conveniently, the diluent is water. Optional components such as acids and. bases may be added to the solvent to act as a peptization agent in the preparation of an extrudable dough.

The zirconium, present as zirconia, in the zirconia extrudate prepared according to the present invention, may itself be used as the catalytically active component. If desired, however, the mixture to be mulled may also comprise sources for one or more other elements to be used as the catalytically active component instead of or in addition to the zirconium, optionally together with one or more promoter elements. Accordingly, the mixture may comprise a source for one or more elements selected from Groups IB, IIB, IIIB, IVB, VB, VIB, VIIB, VIII or the Periodic Table of Elements, or the Lanthanides and Actinides. Preferred catalytically active components are the elements in Group VIII of the Periodic Table. Sources of elements selected from iron, ruthenium, cobalt, rhenium, nickel, palladium, platinum, copper and zinc are especially preferred. Cobalt, iron and nickel are particularly preferred catalytically active elements, with cobalt being most preferred. The mixture may also advantageously comprise a source for an element in Group IVB of the Periodic Table, which elements find use as promoters, in particular titanium, together with, if desired, an additional source for zirconium.

Optionally, binder materials can be used in the preparation of the zirconia extrudates herein. Suitable binders include silica, alumina and titania, and the like.

The source of the one or more elements from the aforementioned group may be either soluble or insoluble in the solvent. Typical sources include salts derived from organic acids, for example acetates, benzoates, ethanoates and propionates; halides, for example chlorides, bromides, iodides and fluorides; and other salts, for example nitrates, oxides, hydroxides, carbonates and chlorates. Sources insoluble in the solvent are preferred. Hydroxides have been found to be particularly preferred.

In a preferred embodiment of the present invention the particulate zirconia is mixed with a cobalt precursor and solvent to form a shapable dough which is then extruded to provide a cobalt catalyst on a zirconia carrier. Hence according to a further aspect of the present invention there is provided a process for preparing a calcined cobalt/zirconia comprising the steps of:

a. preparing a shapable dough which comprises mixing and kneading a particulate zirconia and a cobalt precursor with a solvent to obtain a mixture having a solids content of from about 50% to about 85% by weight,

b. extruding the shapable dough to form a zirconia/cobalt extrudate, and

c. drying and calcining the zirconia/cobalt extrudate;

characterized in that the particulate zirconia comprises no more than about 15% by weight of zirconia which is other than monoclinic zirconia.

The present invention further provides a calcined zirconia/cobalt extrudate prepared by the process described herein.

Suitable cobalt precursors for use herein include any cobalt precursor which leaves only cobalt oxide on the zirconia support after calcination so that the catalytic performance of the final product is not impaired. Suitable cobalt precursors include, but are not limited to, cobalt hydroxide, cobalt acetate, cobalt nitrate, cobalt oxide and mixtures thereof. A particularly preferred cobalt precursor for use herein is cobalt hydroxide.

It is preferred to include in the mixture a basic component to act as a peptizing agent for the preparation of an extrudable dough of zirconia. The basic compound is preferably ammonia, an ammonia-releasing compound, an ammonium compound or an organic amine. Such basic compounds are removed upon calcination and are not retained in the extrudates to impair the catalytic performance of the final product. The basic compound is most preferably an ammonium compound. A most suitable ammonium compound is ammonia.

The amount of basic compound included in the mixture should be sufficient to peptize the zirconia present in the mixture. The amount of basic compound present-in the mixture can be readily determined by measuring the pH of the mixture. During mulling the mixture should preferably have a pH in the range of from 8.0 to 11.5, preferably from about 9.0 to about 11.0.

For the preparation of a co-mulled zirconia/cobalt shapable dough, it is preferred to include in the mixture an acid component to act as a peptizing agent. The acid compound is preferably a mineral acid compound or an organic acid compound. Such acid compounds are removed upon calcination and are not retained in the extrudates to impair the catalytic performance of the final product. A preferred mineral acid for use herein is nitric acid. A most suitable organic acid is citric acid.

To improve the flux properties of the mixture during extrusion a surface active agent or polyelectrolyte may be added to the mixture. The addition of the surface active agent results in a smoother extrudate texture and facilitates cutting of the extruded product. Further, the formation of micropores in the calcined catalytic material may be improved which may enhance catalytic properties of the products. Suitable surface active agents include cationic surface active agents, for example, fatty amines, quaternary ammonium compounds, aliphatic monocarboxylic acids, ethoxylated alkyl amines, polyvinyl pyridine, sulphoxonium, sulphonium, phosphonium and iodonium compounds; anionic surface active agents, for example, alkylated aromatic compounds, acyclic monocarboxylic acids, fatty acids, sulphonated aromatic compounds, alcohol sulphates, ether alcohol sulphates, sulphated fats and oils and phosphonic acid salts; and non-ionic surface active agents, for example polyethylene alkylphenols, polyoxyethylene alcohols, polyoxyethylene alkylamides, polyols, polyvinyl alcohol and acetylenic glycols. The amount of surface active agent is typically from about 0.5 to about 8% by weight, preferably from about 1 to about 5% by weight, based on the weight of zirconia and/or zirconia precursor present in the mixture. The surface active agent may be added at any stage of the mixing prior to extrusion.

In principle, it is possible to combine the components of the mixture in any order. However, it has been found advantageous to prepare the mixture in the following manner. At the very least, the mixture comprises zirconia and a solvent, which are first mixed together. If the mixture is to include a basic compound, it has been found advantageous to add the basic compound to the solvent before introducing the solvent to the particulate zirconia. If desired, a source of one or more elements in the aforementioned groups of the Periodic Table may be added. As discussed herein, a preferred element is cobalt. In the case of a co-mulled zirconia/cobalt extrudate the particulate zirconia and cobalt precursor are mixed together followed by addition of solvent and, if present, acid. A surface active agent, if desired, may be added at any time during mixing, preferably towards the end of mixing.

Typically, the mixture is mixed by mulling for a period of from about 10 to about 120 minutes, preferably from about 15 to about 90 minutes. During the mulling process energy is introduced into the mixture by the mulling apparatus. A Simpson Mixer Muller, Type LG, is used for the mulling process, commercially available from Simpson Technologies Corporation, 751 Shoreline Drive, Aurora, Ill. 60504, USA. Optionally, an AOUSTIN kneader commercially available from F. Aoustin & Cie, 11, Rue de Preaux BP 32, 76161 Darnetal Cedex, France may be used for the kneading process.

The mulling process may be carried out over a broad range of temperature, preferably from about 15 to about 50° C. As a result of the energy input into the mixture during the mulling process, there will be a rise in temperature of the mixture during the mulling. The mulling process is conveniently carried out at ambient pressure. Any suitable, commercially available mulling machine may be employed. At the end of the mulling process, a shapable dough is obtained.

The shapable dough is then extruded using any conventional, commercially available extruder. In particular, a screw-type extruding machine may be used to force the mixture through orifices in a die plate to yield catalyst extrudates of the required shape. The strands formed on extrusion may then be cut to the appropriate length.

The extrudates may have the form of cylinders, including hollow cylinders, or may have a form which is multilobed or twisted multilobed in cross section, or take any other form known in the art. Typically, the extrudates have a nominal diameter of from about 0.5 to about 6 mm, preferably from about 0.8 to about 4 mm, especially from 1 to 3 mm.

After extrusion the extrudates are dried, e.g. at a temperature from about 100 to about 300° C. for a period of about 30 minutes to about 3 hours, prior to calcination. Calcination is conveniently carried out in air at a temperature up to about 1000° C., preferably in the range of from about 300 to about 1000° C., more preferably in the range of from about 300° C. to about 800° C., especially in the range of from about 400° C. to about 600° C. Calcination of the extrudates is typically effected for a period of up to about 5 hours, preferably from about 30 minutes to about 4 hours.

The surface area of the zirconia extrudates is preferably in the range of from about 40 and about 300 m²/g, more preferably from about 50 to about 100 m²/g, as measured by a nitrogen adsorption BET method described in J. Amer. Chem. Soc., 60 (1938), 309.

Once prepared, the extrudates may be subjected to a deposition stage in which sources of one or more catalytically active elements or promoter elements are deposited on the extrudates. The sources may be any of the elements in the groups of the Periodic Table as discussed hereinbefore. In cases in which the original mixture comprised a source for a given element, the deposition of a further source for that element may be effected to increase the loading of the-element on the extrudates.

Deposition of a source of a catalytically active element or a promoter element on the extrudates may be effected by any of the techniques known in the art.

A preferred technique for the deposition is impregnation. Impregnation may be effected by contacting the extrudates with a compound of the desired element in the presence of a liquid, preferably in the form of a solution of a compound of the element. Suitable liquids for use in the impregnation include both organic and inorganic liquids, water being a most convenient and preferred liquid. Suitable compounds of the desired element include both organic and inorganic compounds, with a preference for compounds which are soluble in the selected solvent. It should be noted that addition of acid or bases may facilitate the solubility of suitable compounds of the desired element. Preferably, the compounds are inorganic compounds. Most preferred are aqueous nitrates and hydroxide solutions of the desired element. Especially preferred are nitrate compounds of the desired element since these can be used as a melt thus resulting in a high concentration of the desired element in the liquid.

The extrudates are most conveniently contacted with the compound of the desired element by immersion in the liquid. Preferably, the extrudates are immersed in a sufficient volume of liquid so as to just fill the volume of pores in the extrudates.

If the impregnation is conducted in a single stage, the extrudates are contacted simultaneously with a compound of each of the desired elements in the present of a liquid. Preferably, the extrudates are immersed in an aqueous solution of nitrates or hydroxides of the desired elements. If the impregnation is conducted in a plurality of stages, the extrudates are contacted in a first stage with a compound of one of the desired elements in the presence of a liquid and in a subsequent stage with a compound of a further desired element in the presence of a liquid. The liquid may be the same or different in the stages, most conveniently the same.

After the impregnation, if in a single stage, or after each impregnation in a multi-stage impregnation, the extrudates are dried. The conditions under which the extrudates are dried are those as hereinbefore described. Preferably, after the or each drying process, the extrudates are calcined, the calcination conditions being those as hereinbefore described.

The catalytically active element may be present in the product in an amount of from about 1 to about 100 parts by weight, preferably from about 10 to about 50 parts by weight, per 100 parts by weight of zirconia. The promoter, if present, may be present in an amount of from about 0.1 to about 60 parts by weight, preferably from about 1 to about 10 parts by weight, per 100 parts by weight of zirconia.

In a preferred embodiment of the invention a zirconia extrudate is impregnated with a cobalt precursor which is then dried and calcined to form a calcined cobalt-impregnated zirconia extrudate. Hence according to a further aspect of the present invention there is provided a process for preparing a calcined cobalt-impregnated zirconia extrudate which comprises the steps of:

a. preparing a shapable dough which comprises mixing and kneading a particulate zirconia with a solvent to obtain a mixture having a total solids content of from about 50% to about 85% by weight,

b. extruding the shapable dough to form a zirconia extrudate,

c. impregnating the zirconia extrudate with a liquid cobalt precursor to form a cobalt-impregnated zirconia extrudate, and

d. drying and calcining the cobalt-impregnated zirconia extrudate;

characterized in that the particulate zirconia comprises no more than about 15% by weight of zirconia which is other than monoclinic zirconia.

The present invention further provides a calcined cobalt-impregnated zirconia extrudate prepared according to the process described herein.

Suitable liquid cobalt precursors for impregnating the zirconia extrudate include aqueous solutions of cobalt hydroxide, cobalt acetate, cobalt nitrate, and mixtures thereof. A preferred liquid cobalt precursor is an aqueous solution of cobalt nitrate. Another preferred liquid cobalt precursor is an aqueous solution of cobalt hydroxide in ammonia.

The calcined zirconia extrudates prepared according to the present invention exhibit significant improvement in strength compared with calcined zirconia extrudates which are prepared with particulate zirconia which comprises more than about 15% by weight of zirconia which is other than monoclinic zirconia. For practical applications, it is preferred that the strength of the calcined extrudate is greater than 100 N/cm as measured by the standard test method for radial crush strength of extruded catalyst particles (ASTM D6175-98).

At the same time as having a high crush strength, The calcined zirconia extrudates prepared according to the invention also have a high pore volume, preferably about 0.3 ml/g or greater, as measured by mercury intrusion using the method described in H. L. Ritter and L.C. Drake, In. Eng. Chem., Anal. Ed., 17 (1945), 782.

The calcined zirconia extrudates prepared herein also have a high surface area, preferably about 50 m²/g or greater as measured by a nitrogen adsorption, BET method described in J. Amer. Chem. Soc., 60 (1938) 309.

Hence according to a further aspect of the present invention there is provided a calcined zirconia extrudate having the following characteristics:

(a) a pore volume of about 0.3 ml/g or greater;

(b) a radial crush strength of about 100 N/cm or greater; and

(c) a surface area of about 50 m²/g or greater.

The zirconia extrudates prepared according to the present invention may be applied in any process in which a zirconia-based catalyst can be used or is required. The zirconia extrudates can be suitably used, for example, as carriers for catalysts which are normally used in hydrocarbon synthesis reactions such as the Fischer-Tropsch reaction, hydroconversion processes, like the hydrode-metallization, hydrocracking and hydrodesulphurisation of heavy hydrocarbon oils, in the hydrogenation of hydrogenatable components or hydrocarbon fractions such as kerosene and various types of cycle oils, in the epoxidation of olefinically unsaturated compounds with organic hydroperoxides, in the hydration of olefinically unsaturated compounds to produce the corresponding alkanols, in the purification of exhaust gases, in particular in the denoxing of nitrogen-containing oxygenates, in isomerization of olefins or paraffins, dimerisation of olefins and dehydration of alcohols to olefins.

The zirconia extrudates are especially useful herein as catalyst carriers in Fischer-Tropsch type reactions aimed at producing (long chain) hydrocarbons from carbon monoxide and hydrogen.

Hence according to a further aspect of the present invention there is provided the use of a calcined zirconia extrudate as prepared herein as catalyst carrier in the preparation of hydrocarbons by reacting carbon monoxide and hydrogen under Fischer-Tropsch reaction conditions.

Particularly preferred for use in such reactions are zirconia extrudates prepared according to the present invention comprising elements, optionally with one or more promoters, that are active, after reduction. Of particular use in Fischer-Tropsch syntheses are zirconia extrudates prepared according to the process of the present invention comprising iron, nickel or cobalt as the catalytically active component. Cobalt is particularly preferred.

The zirconia extrudates prepared herein can be reduced by contact with a hydrogen-containing gas at elevated temperature and pressure. Typically, the reduction involves treating the catalyst at a temperature in the range of from 100 to 450° C., and at a pressure of from 1 to 200 bar abs, for 1 to 200 hours. Pure hydrogen may be used in the reduction, but it is usually preferred to apply a mixture of hydrogen and an inert gas, like nitrogen. The relative amount of hydrogen present in the mixture may range between 0.1 and 100 % by volume.

According to a preferred embodiment of the reduction, the catalyst is brought to the desired temperature and pressure level in a nitrogen atmosphere. Subsequently, the catalyst is contacted with a gas mixture containing only a small amount of hydrogen gas, the rest being nitrogen gas. During the reduction, the relative amount of hydrogen gas in the gas mixture is gradually increased up to 50% by volume or even 100% by volume.

Thereafter the resulting catalyst may be contacted with a mixture of carbon monoxide and hydrogen at an elevated temperature and pressure. Typically, the reaction is effected at a temperature in the range of from 125 to 350° C., preferably from 175 to 250° C., more preferably from 200° C. to 250° C., especially from 205° C. to 240° C. The reaction pressure is typically in a range of from 5 to 150 bar abs., preferably from 5 to 100 bar abs., more preferably from 20 to 100 bar, especially from 40 to 70 bar abs.

The hydrogen and carbon monoxide is typically fed to the process at a molar ratio in the range of from 0.7 to 2.5, preferably in the range of from 1 to 2. Low hydrogen to carbon monoxide molar ratios will increase the C5+ selectivity of the catalysts, i.e. the selectivity of the formation of C5+ hydrocarbons. Unconverted hydrogen and carbon monoxide may be recycled to again contact the catalyst. In such an arrangement, the molar ratio of hydrogen to carbon monoxide in the gas actually contacting the catalyst may be considerably lower than that of the feed gas for example in the range of from 0.4 to 1.1.

The gas hourly space velocity (“GHSV”) may vary within wide ranges and is typically in the range of from 100 to 10,000, preferably 100 to 5000, more preferably from 500 to 3500, even more preferably from 800 to 1600 N1/1/h. The term GHSV is well known in the art and relates to the gas per hour space velocity, i.e. the volume of synthesis gas in N1 (i.e. at the standard temperature of 0° C. and the standard pressure of 1 bar (100,000 Pa)) which is contacted in one hour with one litre of catalyst particles. In the case of a fixed bed catalyst, the GHSV is usually expressed as per litre of the catalyst bed, i.e. including interparticular void space.

The process for the preparation of hydrocarbons may be conducted using a variety of reactor types and reaction regimes, for example a fixed bed or an ebullating regime. A fixed bed regime is preferred. It will be appreciated that the size and shape of the catalyst particles may vary depending on the reaction regime they are intended for. The person skilled in the art will be able to select the most appropriate size and shape for a given reaction regime.

Further, it will be understood that the skilled person is capable of selecting the most appropriate conditions for a specific reactor configuration, the reaction regime and a work-up scheme. For example, the preferred gas hourly space velocity may depend upon the type of reaction regime that is being applied. Thus, if it is desired to operate the hydrocarbon synthesis process with a fixed bed regime, preferably the gas hourly space velocity is chosen in the range of from 500 to 2500 N1/1/h.

The products of such Fischer-Tropsch reactions are a mixture of hydrocarbons including paraffin's, olefins and oxygenates, such as alcohols and aldehydes. The co-mulled zirconia/cobalt extrudates and the cobalt-impregnated zirconia extrudates are particularly suitable herein for the preparation of olefins, especially C₁₁-Cₗ₄ olefins, particularly in combination with a preferred set of Fischer-Tropsch process conditions. C₁₁-C₁₄ olefins are particularly useful as precursors for detergent range alcohols.

Hence according to yet a further aspect of the present invention there is provided a process for the preparation of higher olefins having from 11 to 14 carbon atoms comprising contacting hydrogen and carbon monoxide under Fishcer-Tropsch reaction conditions in the presence, as catalyst, of a calcined zirconia/cobalt extrudate or a calcined cobalt-impregnated zirconia extrudate.

In order to maximise the C₁₁-C₁₄ carbon fraction in the hydrocarbon product stream, while still maintaining a high C5+ yield (of at least 85%), it is preferred to carry out the Fischer-Tropsch reaction under such conditions that the average “alpha” value of the catalyst used is in the range of from about 0.87 to about 0.92, preferably from about 0.9 to about 0.92, especially around about 0.91. The “alpha” value is known in the art as the ASF-alpha value (Anderson-Schulz-Flory chain growth factor). As used herein the average alpha value is the value of the ASF chain growth probability coefficient that best describes the measured hydrocarbon distribution between C₂₀ and C₃₉, that is, the value found by statistical regression cf the measured data, using the so-called “least squares regression” technique which is well known to the person skilled in the art. The value of “alpha” in the range preferred for use herein and as mentioned above provides approximately twice as much of the C₁₁-C₁₄ fraction than a value in the range of 0.95 to 0.96 while still having a relatively high C₅₊ yield.

In order to maximise the olefinicity of the C₁₁-C₁₄ carbon fraction, a preferred set of Fischer-Tropsch process conditions is as follows: contacting hydrogen and carbon monoxide in a molar ratio of from 1.1:1 to 0.4:1 at a weight average bed temperature in the range of from 200 to 250° C., preferably 205 to 240° C., a pressure in the range of from 20 to 100 bar, preferably from 40 to 70 bar and a GHSV of from 100 to 5000 hr⁻¹, preferably from 500 to 3500 hr⁻¹.

Further, in order to maximise the olefinicity of the C₁₁-C₁₄ fraction it is preferred that the catalyst has an average particle diameter of 2.2 mm or less, preferably in the range of from 1 mm to 2 mm.

The amount of catalytically active cobalt on the zirconia carrier is preferably in the range of from about 3 to about 300 parts by weight per 100 parts by weight of zirconia carrier material, more preferably from about 10 to about 80 parts by weight, especially from about 20 to about 60 parts by weight.

A preferred reaction product from the Fischer-Tropsch reactions described herein comprises 20 to 60% by weight of C₁₁-C₁₄ olefins, based on the total weight of the C₁₁-C₁₄ carbon fraction. It is also preferred that the Fischer-Tropsch reaction product comprises 85% or more of hydrocarbons having 5 carbon atoms or greater, based on the total weight of hydrocarbons in the reaction product.

The invention will now be illustrated by means of the following Examples.

### EXAMPLES

In the following examples, the term Loss on Ignition (or “LOI”) is the amount of moisture present in a sample as measured by the weight loss of that sample after treatment at 550° C. in a furnace for 2 hours.

### Example 1

### (Calcined Zirconia Extrudate)

A calcined zirconia extrudate according to the present invention is prepared as follows. 7060 grams of zirconium oxide powder having a tradename DAIICHI RC-100, (commercially available from DKK Daiichi Kigenso Kagaku Kogyo Co. Ltd.) and having a Loss on Ignition of 1.9%), are mixed with 2654 grams of water, 416 grams of an ammonia solution (containing 25% by weight of ammonium hydroxide), 69 grams of SUPERFLOC N100 (a polyelectrolyte commercially available from Cytec Industries B.V., Botlekweg 175, 3197 KA, Botlek-Rotterdam, The Netherlands) and 139 grams of polyvinyl alcohol (MOWIOL 8-88 commercially available from Kuraray Specialties Europea, GmbH, c/o Clariant Benelux N.V., Diemerhof 36, 1112 XN Diemen, The Netherlands).

X-ray analysis on the Daiichi powder using Rietveld quantification indicates that it contains 92.09% monoclinic zirconia, 7.9% tetragonal zirconia and 0.006% cubic zirconia; all numbers being +/−10% relative accuracy. The X-ray diffraction instrument used for these measurements is a Philips PW 1800 X-ray diffractometer having the following settings: X-ray tube: copper anode; Voltage: 40 kV; Currrent: 55 mA; Divergence slit: Automatic; Receiving slit: Fine; Vertical soller slits in primary and diffracted beam; Graphite monochromator in difrracted beam; Recorded range: 10-90 2 Theta; Stepsize: 0.025 2 Theta; Counting time/step: 5 seconds; Standard sample holder with 20 mm diameter and 1.5 mm depth.

This mixture is kneaded in a SIMPSON mix-muller Type LG (commercially from Simpson Technologies Corporation) for 15 minutes. Then the mixture is passed through an AOUSTIN kneader, continuous-mixer size 2″××17″ (commercially available from F. Aoustin & Cie, 11, Rue de Preaux BP 32, 76161 Darnetal Cedex, France) at 200 rpm. The dough obtained has a measured LOI of 32.81% and a pH of 10.3. The dough is extruded with a 2.25 inch BONNOT extruder (commercially available from The Bonnot Company, 1520 Corporate Woods Pkwy., Uniontown, Ohio 44685, USA) using a 2.5 mm trilobe die plate and a 1.5 mm cylinder die plate. The extrudates are dried at 120° C. for 1 hour followed by calcination in a rotary oven at a product temperature of 550° C. for 2 hours. The surface area of the final extrudate is 88 m²/g. The pore volume is 0.326 ml/g. The radial crush strength of the final extrudate was measured using the standard test method ASTM D6175-98. Results are shown in Table 1 below.

### Example 2

### (Comparative Example)

The procedure of Example 1 is repeated except that the zirconia powder used in Example 1 is replaced by a mixture of 80% Daiichi HC-100 and 20% of a zirconia powder having the tradename SEPR HC 15 (commercially available from Societe Europeenne des Produits Refractaires, Les Miroires, 18 Rue D'Alsace, 92400 Courbevoie, France). SEPR HC 15 contains 98.3 wt % tetragonal zirconia and 1.7 wt % monoclinic zirconia (as analysed by X-ray diffraction using the same X-ray diffraction instrument and the same settings as described in Example 1 above) and has a LOI of 24.4%. In order to achieve a similar LOI of the extrusion dough as in Example 1, the amount of water added is reduced. The dough obtained has a measured LOI of 32.87% and a pH of 10.2. Extrusion, drying and calcination is carried out in the same way as for Example 1. The radial crush strength of the final extrudate was measured using the standard test method ASTM D6175-98. Results are shown in Table 1 below.

### Example 3

### (Comparative Example)

The procedure of Example 1 is repeated except that the zirconia powder used in Example 1 is replaced by a mixture of 50% Daiichi RC-100 and 50% of a zirconia powder having the tradename SEPR HC15 (as used in Example 2). In order to achieve a similar LOI of the extrusion dough as in Example 1, the amount of water is reduced. The dough obtained has a measured LOI of 31.89% and a pH of 9.8. Extrusion, drying and calcination is carried out in the same way as for Example 1. The radial crush strength of the final extrudate was measured using the standard test method ASTM D6175-98. Results are shown in Table 1 below.

### Example 4

### (Comparative Example)

The procedure of Example 1 is repeated except that the zirconia powder used in Example 1 is replaced by the zirconia powder SEPR HC 15 (as used in Example 2). In order to achieve a similar LOI of the extrusion dough as in Example 1, the amount of water added is reduced. The dough obtained has a measured LOI of 31.89% and a pH of 9.8. Extrusion, drying and calcination is carried out in the same way as for Example 1. The radial crush strength of the final extrudate was measured using the standard test method ASTM D6175-98. Results are shown in Table 1 below.

### Example 5

### (Comparative Example)

The procedure of Example 1 is repeated except that the zirconia powder used in Example 1 is replaced by the zirconia powder SEPR HC 15 (as used in Example 2) which has been calcined at 400° C. before adding to the extrusion mix. The powder consists of a mixture of tetragonal (98.3%) and. monoclinic (1.7%) zirconia as analysed by X-ray diffraction (using the same X-ray diffraction instrument and settings as described in Example 1 above) and has an LOI of 3.2%. In order to achieve a similar LOI of the extrusion dough as in Example 1, the amount of water added is reduced. The dough obtained has a measured LOI of 33.75% and a pH of 9.8.Extrusion, drying and calcination is carried out in the same way as for Example 1. The radial crush strength of the final extrudates are measured using the standard test method ASTM D6175-98. Results are shown in Table 1 below.

### Example 6

### (Comparative Example)

The procedure of Example 1 is repeated except that the zirconia powder used in Example l is replaced by a zirconia powder, MEL XZO 880/1 (commercially available from MEL Chemicals, Clifton Junction, P.O. Box 6, Swinton, M27 8LS, Manchester, UK). This powder consists of 100% tetragonal zirconia as analysed by X-ray diffraction (using the same X-ray diffraction instrument and settings as described in Example 1 above) and has a LOI of 1.9%. In order to achieve a similar LOI of the extrusion dough as in Example 1, the amount of water added is reduced. The dough obtained has a measured LOI of 48.5% and a pH of 9.3. Extrusion, drying and calcination is carried out in the same way as for Example 1 (except that only a 2.5 mm cylinder die plate was used). The radial crush strength of the final extrudate is measured using the standard test method ASTM D6175-98. Results are shown in Table 1 below.

TABLE 1

| | |
|---|---|
| Wt % of | |
| monoclinic | Radial crush |
| zirconia in | strength N/cm |

| | starting | 2.5 mm | 1.5 mm |
|---|---|---|---|
| Example | powder | trilobe | cylinder |
| 1 | 92.09 | 208 | 154 |
| 2(Comparative) | 74 | 106 | 67 |
| 3(Comparative) | 46.9 | 32 | 25 |
| 4(Comparative) | 1.7 | <20 | <20 |
| 5(Comparative) | 1.7 | <20 | <20 |
| 6(Comparative) | 0 | 20 N/cm | Not |
| | | | measured |

The data provided in Table 1 clearly demonstrates that calcined zirconia extrudates that have been prepared using zirconia powder which consists essentially of monoclinic zirconia (e.g. 92.09%) have a significantly higher crush strength than those which have been prepared using tetragonal zirconia or a mixture of monoclinic and tetragonal zirconia.

### Example 7

### (Calcined Zirconia Extrudate Prepared Without the Addition or Acid or Base)

264 grams of zirconium oxide powder having the tradename DAIICHI RC-100 (as used in Example 1) with a LOI of 5.3% are mixed with 90 grams of a 5% w polyvinyl alcohol solution in water (having the tradename MOWIOL 18-88). This mixture is kneaded in a Sigma (Z-blade) kneader type LUK 0.5 supplied by Werner & Pfleiderer, Stuttgart, Germany for 2 minutes. 2.5 grams of SUPERFLOC N100 is added to the mixture and mixing is continued for 5 minutes. 8 grams of water is then added to the mixture and mixing is continued for 30 minutes. The dough thus obtained has a measured LOI of 31.5% and a pH of 8.4. This dough is extruded using a 1 inch single screw pinned extruder (supplied by The Bonnot Company) using a 1.6 mm trilobe die plate. The extrudates are dried at 120° C. for 1 hour followed by calcinations in a stationary oven at a product temperature of 550° C. for 2 hours. The pore volume of the finished extrudates is 0.312 ml/g and the surface area is 55 m²/g. The radial crush strength of the finished extrudates is 233 N/cm. This example demonstrates that it is not necessary to use acid or base in the preparation process of the present invention. Therefore in cases where acid or base would lead to deleterious effects on the catalyst, the use of acid or base in the preparation of the extrudate can be avoided.

### Example 8

### (Calcined Cobalt-Impregnated Zirconia Extrudate)

The procedure of Example 1 is repeated except that dough is extruded using a 1.0 mm trilobe die plate. The extrudates are dried at 120° C. for 1 hour followed by calcinations in a rotary oven at a product temperature of 550° C. for 2 hours. This procedure was repeated and the two products were mixed. The final product has a surface area of 60.5 m²/g as measured by a nitrogen adsorption BET method described in J. Amer. Chem. Soc., 60 (1938) 309, a pore volume of 0.352 ml/g as measured by the mercury intrusion method described in H. L. Ritter and L. C. Drake, In. Eng. Chem., Anal. Ed., 17 (1945) 782 and a radial crush strength of 154 N/cm as measured by the same test method as is used in Example 1.

10250 grams of the resulting extrudate is heated to 60 C. and impregnated with 6938 grams of a molten cobalt nitrate solution having a temperature of 60° C. for a period of 2 minutes during which the average temperature of the impregnating mass is around 60° C. The impregnated extrudates are dried at 120° C. and calcined in a rotary furnace at a product temperature of 445° C. The final extrudates have a cobalt content of 11.45% by weight (as measured by X-ray fluorescence), a surface area of 48 m²/g (as measured by a nitrogen adsorption BET method described in J. Amer. Chem. Soc., 60 (1938) 309) and a radial crush strength of 188 N/cm as measured by the same test method as is used in Example 1.

### Example 9

### (Calcined Co-Mulled Cobalt/Zirconia Extrudate)

18749 grams of zirconium oxide DAIICHI RC-100 powder is mixed with 8091 grams of cobalt hydroxide. The dry powders are blended in a Simpson mix muller. To this blend is added 5729 grams of a 5 wt % solution of polyvinyl alcohol (MOWIOL 18-88) in water, 210.5 gram solid polyvinyl alcohol (MOWIOL 18-88), 255 gram citric acid and 2802 gram water. This mixture is kneaded for 36 minutes in a SIMPSON mix muller. Then 505 gram of SUPERFLOC N100 is added and mixing is continued for another 5 minutes. The dough thus obtained has a measured LOI of 31.8% and the pH is 7.8. This dough is extruded using a 2.25 inch BONNOT extruder using a 1.0 mm trilobe die plate. The extrudates are dried at 120° C. for 4 hours followed by calcination in a stationary oven at a product temperature of 550° C. for 1 hour. This procedure is repeated and the two products are mixed. The final product has a strength of 113 N/cm.

### Example 10

The extrudates prepared according to Examples 8 and 9 are converted into active Fischer-Tropsch catalysts by reduction, and subsequently subjected to Fischer-Tropsch reaction conditions as follows.

A micro-flow reactor containing the catalyst particles in the form of a fixed bed are heated to a temperature of 280° C., and pressurized with a continuous flow of nitrogen gas to a pressure of 1 bar abs. The catalyst is reduced in-situ for 24 hours with a mixture of nitrogen and hydrogen gas. During reduction the relative amount of hydrogen in the mixture is gradually increased from 0% v to 100% v. The water concentration of the off-gas is kept below 3000 ppmw.

Following reduction, the preparation of hydrocarbons is carried out by introducing a mixture of hydrogen and carbon monoxide at a H₂/CO ratio of 1.1:1. The GHSV, the reaction temperature (expressed as the weighted average bed temperature), and the pressure are set according to Table 2. The space time yield (STY), expressed as grams hydrocarbon product per liter catalyst particles (including voids between the particles) per hour; the selectivity to hydrocarbons containing 5 or more carbon atoms (C5+ selectivity), expressed as % wt of the total hydrocarbon product; the selectivity to hydrocarbons containing 11-14 carbon atoms (C₁₁-C₁₄ selectivity), expressed in % wt of the total hydrocarbons product; and the selectivity to hydrocarbons containing 15-20 carbon atoms (C₁₅-C₂₀ selectivity.), expressed in % wt of the total hydrocarbons product, were determined after 40 hours of operation. The results are set out in Table 2 below.

TABLE 2

| | Catalyst of | Catalyst of |
|---|---|---|
| | Example 8 | Example 9 |
| Temperature, ° C. | 231 | 227 |
| Pressure, bar abs. | 51 | 52 |
| GHSV, NL/(l · hr) | 1200 | 1200 |
| STY, g/(l · hr) | 148 | 151 |
| C5+ selectivity, % w | 88 | 87 |
| C₁₁-C₁₄ selectivity, % w | 9 | 9 |
| C₁₅-C₂₀ selectivity, % w | 13 | 13 |

The results set out in Table 2 demonstrate that the Co/Zr catalysts prepared according to the present invention can be successfully used as catalysts in the Fischer-Tropsch synthesis of hydrocarbons.

### Example 11

In the following example the catalyst prepared in accordance with Example 8 above is compared with two other catalysts (Catalysts A and B) having different chemical compositions and different preparation methods. Catalyst A is a cobalt catalyst on a silica support having zirconia as a promoter element and is prepared according to Example 11 of EP-A-428223. Catalyst B is a cobalt catalyst on a titania support having manganese as a promoter element prepared in accordance with the general methods as described in WO99/34917 using 110.5 g of titania powder (having the tradename P25 commercially available from Degussa), 51.4 g of a commercially available co-precipitated MnCo(OH), with a Mn/Co ratio (%atom/atom) of 5.6. This mixture is compacted by kneading for 30 minutes. The mixture is shaped using a Bonnot extruder. The extrudates (1.7 mm trilobe) are dried at 120° C. for 2 hours and calcined at 550° C. for 2 hours. The resulting extrudates contain 20 wt % Co, 1 wt % Mn and 71.1 wt % TiO₂.

The three catalysts are converted into active Fischer-Tropsch catalysts by reduction in the same way as for Example 10 above.

Following the reduction, the preparation of hydrocarbons is carried out by introducing a mixture of hydrogen and carbon monoxide at a H₂/CO ratio of 1.1:1. The GHSV, the reaction temperature (expressed as the weighted average bed temperature), and the pressure are set according to Table 3. The space time yield (STY), expressed as grams hydrocarbon product per liter catalyst particles (including voids between the particles) per hour; the selectivity to hydrocarbons containing 5 or more carbon atoms (C₅₊ selectivity), expressed as % wt of the total hydrocarbon product; the selectivity to hydrocarbons containing 11-14 carbon atoms (C₁₁-C₁₄ selectivity), expressed in % wt of the total hydrocarbons product; and the olefinicity of the C₁₁-C₁₄ hydrocarbon product, expressed in % wt of the C₁₁-C₁₄ hydrocarbon product, were determined after 120 hours of operation. The results are set out in Table 3 below.

TABLE 3

| | Catalyst | Catalyst A | Catalyst B |
|---|---|---|---|
| | of Eg 8 | (Comparative) | (Comparative) |
| H₂/CO feed | 1.1 | 1.1 | 1.1 |
| ratio | | | |
| Helium content | 15 | 15 | 15 |
| of feed | | | |
| gas/[% v] | | | |
| Temperature, ° C. | 221 | 221 | 222 |
| Pressure, bar | 60 | 60 | 58 |
| abs. | | | |
| GHSV, | 1200 | 1200 | 1200 |
| NL/(l · hr) | | | |
| STY, g/(l · hr) | 152 | 115 | 170 |
| C₅₊ | 81 | 73 | 87 |
| selectivity, % w | | | |
| C₁₁-C₁₄ | 11.6 | 9.3 | 9.2 |
| selectivity, % w | | | |
| Olefinicity | 31 | 19 | 19 |
| C₁₁-C₁₄, % w | | | |
| C₂₀-C₃₉ alpha | 0.91 | 0.93 | 0.94 |

The results of Table 3 demonstrate that the catalyst of Example 8, prepared in accordance with the present 5 invention, gives a significantly improved C₁₁-C₁₄ olefin yield compared with cobalt catalysts based on other types of supports (such as silica and titania) and prepared using different methods.

### Example 12

Use of a Calcined Solid Acid Zirconia Catalyst in the Reaction of Hydrogen Sulfide with 2-methyl-1-pentene to the Corresponding Mercaptan and Subsequently to the Corresponding Thioether.

A zirconia extrudate is prepared using the method described in Example 7 except that a 1 mm trilobe die plate is used. The drying and calcinations are the same as described in Example 7. The surface area of the extrudates is measured to be 57.7 m² per gram using the BET surface area method described above. The skeletal density of the zirconia measures 5.41 g per ml and the bulk density measures 1.15 g per ml. The pore volume measures 0.316 ml/g. The moisture content of the extrudates is determined by keeping the extrudates at 450° C. for 2 hours. The drop in weight by the thermal treatment amounts to 1.03%. 244 g of the extrudates are evacuated and subsequently impregnated with sulphuric acid. 300 ml of 1 M sulphuric acid is impregnated into the evacuated zirconia extrudates in four steps of 75 ml. After each impregnation step the extrudates are dried in vacuo by raising the temperature to 150° C. by using a silicone oil bath. The sulfate content of the zirconia extrudates is determined by extraction of the extrudates with acetic acid having a pH of 2. The sulfate content of the extract is determined by titration with sodium hydroxide. The content of sulphuric acid of the dried extrudates is determined to be 7.7 wt %. After calcinations for 2 hours at 450° C. the sulfate content drops to 3.4 wt %.

The prepared calcined solid acid catalyst is employed in the reaction of hydrogen sulfide with 2-methyl-1-pentene to the corresponding mercaptan and subsequently to the corresponding thioether. A cylindrical reactor of diameter 4 cm is filled with the catalyst. The height of the catalyst bed is about 10 cm. A flow of 12.5 NI per hour of nitrogen containing 500 ppmv of hydrogen sulfide is passed upwards through the catalyst bed together with a flow of 9 ml per minute of a liquid containing mostly aromatic hydrocarbons such as that commercially available from Shell under the tradename SHELLSOL A 100. The conversion of the hydrogen sulfide at ambient temperature varies from 80 to 90%. The conversion remains at the same level for a period of more than one month. The fact that the conversion did not reach 100% is due to the inefficient transfer of the hydrogen sulfide from the gas phase to the liquid flow. In addition to the reaction of the iso-pentene with hydrogen sulfide, formation of oligomers also takes place.

The Examples show that the zirconia extrudates of the present invention exhibit excellent crush strength and are suitable for use as catalysts or catalyst supports in a wide range of chemical processes.

1-25. (canceled)

26. A process for the preparation of higher olefins having from 11 to 14 carbon atoms comprising contacting hydrogen and carbon monoxide under Fischer Tropsch reaction conditions in the presence of a calcined zirconia/cobalt extrudate selected from the group consisting of:
A) an extrudate prepared by:
a. preparing a shapable dough which comprises mixing and kneading a particulate zirconia with a solvent to obtain a mixture having a total solids content of from about 50% to about 85% by weight,
b. extruding the shapable dough to form a zirconia/extrudate, and
c. drying and calcining the zirconia/cobalt extrudate;
wherein the particulate zirconia comprises no more than about 15% by weight of zirconia which is other than monoclinic zirconia;
B) a zirconia extrudate prepared by:
a. preparing a shapable dough which comprises mixing and kneading a particulate zirconia with a solvent to obtain a mixture having a total solids content of from about 50% to about 85% by weight,
b. extruding the shapable dough to form a zirconia extrudate,
c. impregnating the zirconia extrudate with a liquid cobalt precursor to form a cobalt-impregnated zirconia extrudate, and
d. drying and calcining the cobalt-impregnated zirconia extrudate;
wherein the particulate zirconia comprises no more than about 15% by weight of zirconia which is other than monoclinic zirconia; and
C) a zirconia extrudate having the following characteristics:
a. a pore volume of about 0.3 ml/g or greater;
b. a radial crush strength of about 100 N/cm or greater; and
c. a surface area of about 50 m2/g or greater.

27. The process according to claim 26 wherein the catalyst comprises from about 3 to about 100 parts by weight of cobalt.

28. The process according to claim 26 wherein the catalyst has an average particle size of 2.2 mm or less.

29. The process of claim 26 wherein the amount of catalytic reactive cobalt on the zirconia carrier is preferably in the range from about 3 to about 300 parts by weight for 100 parts by weight of zirconia carrier material.
